(19) United States
(12) Patent Application Publication
(10) Pub. No.: US 2013/0294779 A1
(43) Pub. Date: Nov. 7, 2013

(54) CIRCUIT BOARD ASSEMBLY EMPLOYING OPTICAL TRANSCEIVER FOR SIGNAL TRANSMISSION

(71) Applicant: KAI-WEN WU, Tu-Cheng (TW)

(72) Inventor: KAI-WEN WU, Tu-Cheng (TW)

(73) Assignee: HON HAI PRECISION INDUSTRY CO., LTD., Tu-Cheng (TW)

(21) Appl. No.: 13/597,232

(22) Filed: Aug. 28, 2012

(30) Foreign Application Priority Data
May 4, 2012 (TW) 101115912

(51) Int. Cl. H04B 10/14

(52) U.S. Cl. 398/139

(57) ABSTRACT

A circuit board assembly includes a first circuit board, an optical transceiver, a second circuit board, and a number of light wave guides. The first circuit board includes a lower surface. The optical transceiver is mounted on the lower surface for sending and receiving light beams. The second circuit board is electrically connected to the first circuit board and includes a top surface facing the lower surface. The light wave guides are mounted on the top surface and optically coupled with the optical transceiver for transmitting the light beams.

### BACKGROUND

1. Technical Field

The present disclosure relates to circuit board assemblies and, particularly, to a circuit board assembly employing an optical transceiver for signal transmission.

2. Description of Related Art

A typical circuit board assembly includes a first circuit board, a second circuit board, and at least one optical transceiver. The first circuit board is mounted on a top surface of the second circuit board and electrically connected to the second circuit board. The optical transceiver is mounted on a surface of the first circuit board away from the top surface for sending or receiving light beams. The first circuit board defines a number of through holes for the light beams to pass through. A number of light wave guides are positioned on the top surface and optically coupled with the through holes for transmitting the light beams. However, the through holes are needed to be precisely manufactured, which increase the cost of the circuit board assembly.

Therefore, it is desirable to provide a circuit board assembly, which can overcome the above-mentioned problems.

### BRIEF DESCRIPTION OF THE DRAWING

Many aspects of the present disclosure can be better understood with reference to the drawing. The components in the drawing are not necessarily drawn to scale, the emphasis instead being placed upon clearly illustrating the principles of the present disclosure.

FIG. 1 is a top plan view of a circuit board assembly according to an exemplary embodiment.

FIG. 2 is a schematic side view of the circuit board assembly of FIG. 1.

### DETAILED DESCRIPTION

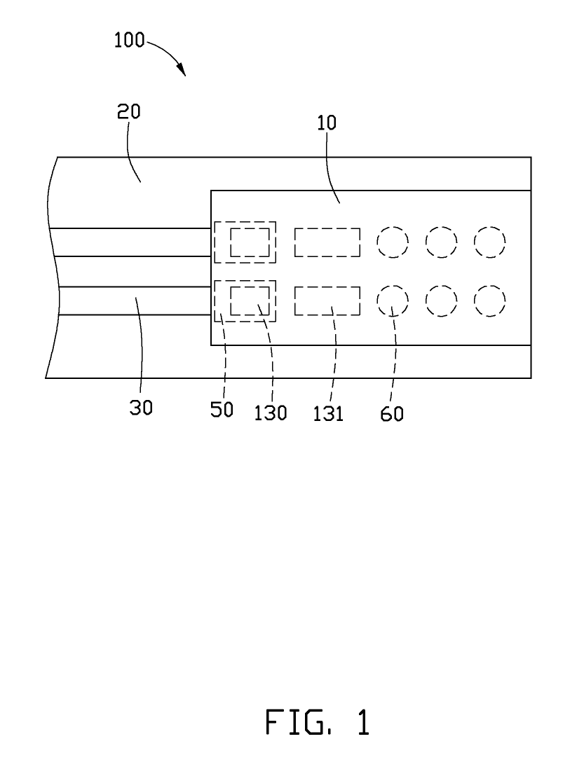

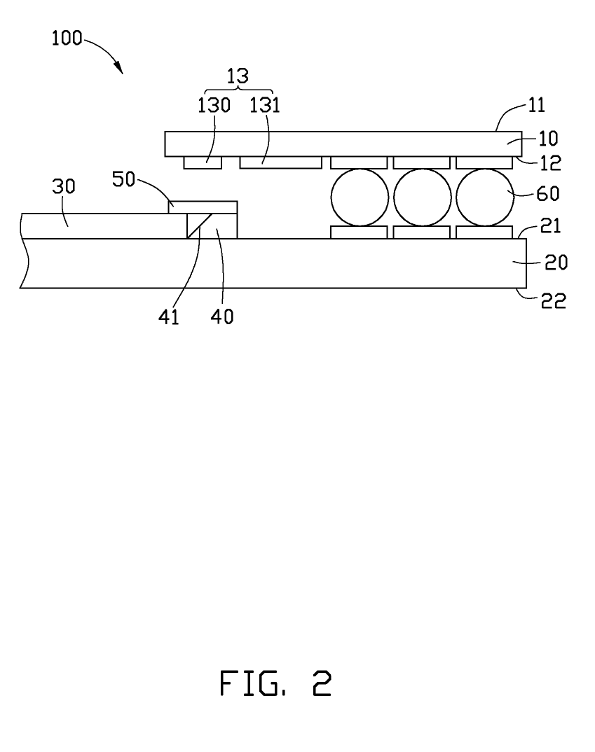

Referring to FIGS. 1 and 2, a circuit board assembly 100 according to an embodiment, is shown. The circuit board assembly 100 includes a first circuit board 10, a second circuit board 20, a number of light wave guides 30, a number of reflecting elements 40, and a number of converging lenses 50.

The first circuit board 10 is a low-temperature co-fired ceramic (LTCC) substrate and includes an upper surface 11, a lower surface 12 opposite to the upper surface 11, and a ball grid array (BGA) 60 mounted on the lower surface 12. The circuit board assembly 100 further includes an optical transceiver 13 mounted on the lower surface 12. The optical transceiver 13 is mounted on and electrically connected to the first circuit board 10 through a chip on board (COB) technology. In the embodiment, the optical transceiver 13 includes two photoelectric elements 130 and two controllers 131. Each photoelectric element 130 is electrically connected to a respective controller 131. One of photoelectrical elements 130 is a laser diode and accordingly the controller 131 connected to the laser diode is a laser driver for driving the laser diode to emit light beams. The other photoelectrical element 130 is a photodiode for converting light beams to electric signals and accordingly the other controller 130 connected to the photodiode is a processor for processing electric signals.

The second circuit board 20 can be a rigid printed circuit board or a flexible printed circuit board. In the embodiment, the second circuit board 20 is a rigid printed circuit board. The second circuit board 20 includes a top surface 21 and a bottom surface 22 opposite to the top surface 21. The top surface 21 faces the lower surface 12. The lower surface 12 is soldered to the top surface 21 through the BGA 60, such that the first circuit board 10 is electrically connected to the second circuit board 20.

The light wave guides 30 are directly positioned on the top surface 21 by a planar light wave guide circuit (PLC) technology. In the embodiment, there are two light wave guides 30 parallel to each other. One end of each light wave guide 30 is adjacent to one of the photoelectric elements 130.

The reflecting elements 40 are mounted on the top surface 21. In the embodiment, there are two reflecting elements 40. Each reflecting element 40 includes a reflecting surface 41. An included angle between the reflecting surface 41 and the top surface 21 is about 45 degrees. The reflecting surface 41 of each reflecting element 40 is aligned with a photoelectric element 130 and positioned in a light path between one of the photoelectric elements 130 and one of the light wave guides 30. An included angle between the reflecting surface 41 of each reflecting element 40 and an optical axis of each photoelectric element 130 is about 45 degrees.

The number of the converging lenses 50 is two. Each converging lenses 50 is fixed to each reflecting element 40 and one end of each light wave guide 30 adjacent to a respect one of the photoelectric elements 130. Each converging lens 50 is aligned with a respective photoelectric element 130.

When the optical transceiver 13 sends light beams, the laser driver drives the laser diode to emit light beams. The light beams pass through one of the converging lenses 50, then the light beams are projected to one of the reflecting elements 40 and reflected the one of the reflecting elements 40 and guided into a respective first wave guide 30. Then the lights beams are transmitted by the light wave guide 30. When the optical transceiver 13 receives light beams, light beams emit through the other light wave guide 30 and are projected onto the other reflecting element 40 and are reflected by the other first reflecting element 40. Then the light beams pass through the other converging lenses 50. The light beams are finally received by the photodiode and converted to electric signals by the photodiode.

In alternative embodiments, the number of each of the laser diodes, the photodiodes, and the light wave guides 30 is not limited in this embodiment but can be set depending upon requirements. For example, in other embodiments, two laser diodes and two photodiodes are employed. Accordingly, four reflecting elements 40, four converging lenses 50, and four light wave guides 30 are employed.

In alternative embodiments, the reflecting elements 40 can be integrated formed with each other.

In alternative embodiments, the converging lenses 50 can be integrated formed with each other.

In alternative embodiments, the reflecting element 40 can be omitted. Each light wave guide 30 is optically coupled with a photoelectric element 130 by other optical elements such as an optical integrator.

In alternative embodiments, the converging lenses 50 can be omitted.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A circuit board assembly, comprising:
a first circuit board comprising a lower surface;
an optical transceiver mounted on the lower surface for sending and receiving light beams;
a second circuit board electrically connected to the first circuit board and comprising a top surface facing the lower surface; and
a number of light wave guides positioned on the top surface and optically coupled with the optical transceiver for transmitting the light beams.

2. The circuit board assembly of claim 1, wherein the optical transceiver comprises two photoelectric elements, one of photoelectrical elements is a laser diode and the other photoelectrical element is a photodiode.

3. The circuit board assembly of claim 2, wherein the number of the light wave guides is two, each light wave guide is optically coupled with a respect one of the photoelectric elements.

4. The circuit board assembly of claim 3, wherein the circuit board assembly comprises two reflecting elements mounted on the top surface, each reflecting elements is aligned with a respective one of the photoelectric elements and positioned in a light path between the respective photoelectric element and a respective one of the light wave guides.

5. The circuit board assembly of claim 4, wherein the circuit board assembly comprises two converging lenses, each converging lenses is fixed to a respective one of the reflecting elements and an end of a respective one of the light wave guides adjacent to a respect one of the photoelectric elements, each converging lens is aligned with a respect one of the photoelectric elements.

6. The circuit board assembly of claim 4, wherein each reflect element comprises a reflecting surface, an included angle between the reflecting surface and the top surface is about 45 degrees.

7. The circuit board assembly of claim 6, wherein an included angle between the reflecting surface of each reflecting element and an optical axis of each photoelectric element is about 45 degrees.

8. The circuit board assembly of claim 1, wherein the light wave guides are positioned on the top surface by a planar light wave guide circuit technology.

9. The circuit board assembly of claim 1, wherein the first circuit board is a low-temperature co-fired ceramic substrate.

10. The circuit board assembly of claim 1, wherein the first circuit board is soldered to the top surface through a ball grid array mounted between the lower surface and the top surface.
